(19) United States
(12) Patent Application Publication
(10) Pub. No.: US 2025/0317933 A1
(43) Pub. Date: Oct. 9, 2025

(54) IMPACT ON UPLINK DATA TRANSMISSION DUE TO CELL DEACTIVATION

(71) Applicant: Continental Automotive Technologies GmbH, Hannover (DE)

(72) Inventors: Rikin Shah, Langen (DE); Hojin Kim, Regensburg (DE); Andreas Andrae, Frankfurt am Main (DE); David Gonzalez Gonzalez, Egelsbach (DE); Reuben George Stephen, Singapore (SG)

(73) Assignee: Continental Automotive Technologies GmbH, Hannover (DE)

(21) Appl. No.: 18/863,352

(22) PCT Filed: May 5, 2023
(86) PCT No.: PCT/EP2023/062004

§ 371 Date: Nov. 6, 2024

(30) Foreign Application Priority Data
May 6, 2022 (DE) 10 2022 204 462.2

(51) Int. Cl. H04W 72/21; H04W 36/00

(52) U.S. Cl. CPC H04W 72/21; H04W 36/0055

(57) ABSTRACT

Controlling data transmission in a cellular network system according to cell deactivation based on a quality of service (QoS) of user equipment. A network cell determines a time interval for uplink data transmission of user equipment according to the quality of service of the user equipment. Based on whether a deactivation time of the cell serving the user equipment will expire before the time interval, the user equipment may trigger a handover to a target cell before expiration of the deactivation time.

### CROSS-REFERENCE TO RELATED APPLICATIONS

The present application is a National Stage Application under 35 U.S.C. § 371 of International Patent Application No. PCT/EP2023/062004 filed on May 5, 2023, and claims priority from German Patent Application No. 10 2022 204 462.2 filed on May 6, 2022, in the German Patent and Trademark Office, the disclosures of which are herein incorporated by reference in their entireties.

### TECHNICAL FIELD

The present application relates to cellular networks, and more particularly to a user equipment (UE) and cell for improved network energy savings with respect to both cell transmission and reception in a cellular network.

### BACKGROUND ART

Energy efficiency of user equipment in a cellular network system has been extensively studied. However, in effort to promote a more environmentally conscious cellular network system, techniques for improving network energy savings with respect to both the user equipment and cells have been considered. Accordingly, techniques with respect to cell transmission and reception to improve network energy savings have been considered. For example, network energy savings may be accomplished through achieving more efficient operation dynamically and semi-statically and finer granularity adaptation of transmission and reception in one or more of network energy saving techniques in time, frequency, spatial, and power domains, with potential feedback from user equipment; and information exchange/coordination over network interfaces (3GPP RP-213554, 3GPP TSG RAN Meeting #94e, Dec. 6-17, 2021).

### BRIEF SUMMARY

Aspects of embodiments of the present application relate to a technique including a time interval for achieving network energy savings while avoiding an unnecessary handover of user equipment when a cell or cells is switched off and the user equipment initiates uplink (UL) data transmission.

According to an aspect of an embodiment, there is provided a cellular network system including a user equipment and a network cell configured to determine a time interval for uplink data transmission of the user equipment according to a quality of service of the user equipment and transmit the time interval to the user equipment. The user equipment is configured to compare a remaining deactivation time of the network cell to the time interval and perform uplink data transmission in the network cell or a target cell based on a result of comparing the deactivation time to the time interval.

According to an aspect of an embodiment, there is provided a user equipment including a transceiver and a control unit configured to receive from a network cell servicing the user equipment a time interval of the user equipment based on a quality of service requirement of the user equipment, compare a remaining deactivation time of the network cell to the time interval, and control the transceiver to perform uplink data transmission in the network cell or a target cell based on a result of comparing the deactivation time to the time interval.

According to an aspect of an embodiment, there is provided a method of a user equipment controlling data transmission in a cellular network system according to cell deactivation. The method includes receiving from a network cell servicing the user equipment a time interval of the user equipment based on a quality of service requirement of the user equipment, comparing a remaining deactivation time of the network cell to the time, and performing uplink data transmission in the network cell or a target cell based on a result of comparing the deactivation time to the time interval.

### Technical Problem

To provide network energy savings, for example, when the expected traffic volume is lower than a fixed threshold, a cell or cells may be switched off. However, if a cell or cells is switched off, then an unnecessary handover of user equipment may occur, for example when user equipment initiates uplink (UL) data transmission.

Accordingly, a technique for achieving network energy savings while also avoiding an unnecessary handover of user equipment when a cell or cell is switched off and the user equipment initiates uplink (UL) data transmission would be desirable.

### Solution to Problem

In view of the above, aspects of embodiments of the present application relate to behavior of a user equipment and a cell in a cellular network system that preserve network energy savings while avoiding an unnecessary handover of user equipment when cell is switched off and the user equipment initiates uplink (UL) data transmission. In particular, a time interval is configured for the user equipment. With reference to a deactivation time of the cell, the user equipment may control whether a handover is triggered or uplink data is transmitted based on the time interval and the deactivation time.

### Advantageous Effects

Aspects of embodiments of the present application provide a technique, based on a time interval of a user equipment and a deactivation time of a cell, that eliminates an unnecessary handover of the user equipment when uplink data transmission is required and the serving cell is deactivated.

Aspects of embodiments of the present application provide a technique, based on a time interval of a user equipment and a deactivation time of a cell, that provides a seamless handover of the user equipment when uplink data transmission is required and the serving cell is deactivated.

Aspects of embodiments of the present application provide a technique, based on a time interval of a user equipment and a deactivation time of a cell, that eliminates an unnecessary handover of the user equipment when uplink data transmission and low quality of service (QoS) is required and the serving cell is deactivated.

Aspects of embodiments of the present application provide a technique, based on a time interval of a user equipment and a deactivation time of a cell, that provides a seamless handover of the user equipment when uplink data transmission and high quality of service (QoS) is required and the serving cell is deactivated.

Aspects of embodiments of the present application provide a technique, that preserve network energy savings when a cell or cells is switched off while maintaining user equipment connectivity and quality of service (QoS) when the user equipment initiates uplink (UL) data transmission.

### BRIEF DESCRIPTION OF THE DRAWINGS

The above and other aspects will be more clearly understood from the following brief description taken in conjunction with the accompanying drawings.

FIG. 1 is a block diagram illustrating a cellular network system, according to an embodiment.

FIG. 2 is flowchart illustrating a method of controlling data transmission due to cell deactivation, according to an embodiment.

FIG. 3 is flowchart illustrating a method of controlling data transmission due to cell deactivation, according to an embodiment.

FIG. 4 is a timing diagram illustrating controlling data transmission due to cell deactivation, according to an embodiment.

FIG. 5 is a timing diagram illustrating controlling data transmission due to cell deactivation, according to an embodiment.

### DETAILED DESCRIPTION

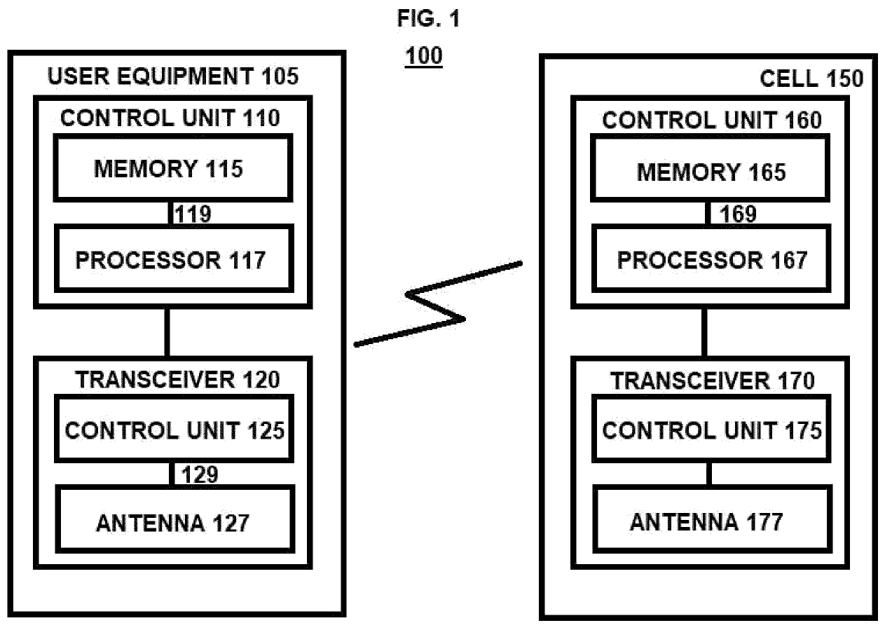

FIG. 1 is a block diagram illustrating a cellular network system, according to an embodiment.

As illustrated in FIG. 1, the cellular network system 100 includes a user equipment (UE) 105 and a cell 150. Although only a single user equipment 110 and cell 120 will be discussed for convenience with respect to in FIG. 1, the artisan of ordinary skill will appreciate that the cellular network system 100 may include a plurality of user equipment and a plurality of cells, which collectively form the cellular network system 100.

The cellular network system 100 may support cellular network communication according to one or more cellular communication standards, such as third generation (3G), fourth generation (4G), long term evolution (LTE), fifth generation (5G), sixth generation (6G), etc. The cellular network system 100 may implement wireless data communication according to one or more of Global System for Mobile Communication (GSM), General Packet Radio Service (GPRS), Universal Mobile Telephone System (UMTS), Code Division Multiple Access (CDMA), Enhanced Data for Global Evolution (EDGE), and the like.

The user equipment 105 includes a control unit 110 and a transceiver 120.

The control unit 110 includes a memory 115, processor 117, and bus 119. Although the user equipment 105 is illustrated as including the memory 115 and processor 117 in FIG. 1, the artisan of ordinary skill will appreciate that the user equipment 105 may include additional components for performing cellular transmission and reception functions of the user equipment 105.

The memory 115 may be random access memory (RAM), solid state or flash memory, electrically erasable programmable read-only memory (EEPROM), or any other suitable data storage element for storing data and/or operating instructions, computer-readable codes, application programming, etc. of the user equipment 105.

The processor 117 may be a central processing unit (CPU), microprocessor, or other suitable data processing element for controlling operations of the user equipment 105 by executing the operating instructions, computer-readable codes, application programming, etc. stored in the memory 115 the user equipment 105.

The memory 115 and the processor 117 may communicate via one or more busses 119.

Although the memory 115 and processor 117 are illustrated as being embodied as separate components connected via bus 119 in FIG. 1, the artisan of ordinary skill will appreciate that the memory 115 and processor 117 may be integrated into a single component, such as an application-specific integrated circuit (ASIC) or other suitable electronic component for executing cellular transmission and reception functions of the user equipment 105.

The transceiver 120 may be communication circuitry configured to wirelessly communicate between the control unit 110 of the user equipment 105 and other entities of the cellular network, such as the cell 150 or other user equipment. The transceiver 120 may be configured to wirelessly communicate according to one or more cellular communication networks or protocols, such as 3G, 4G, LTE, 5G, 6G, GSM, GPRS, UMTS, CDMA, EDGE, and the like.

The transceiver 120 may include a control unit 125 and an antenna 127. Although the transceiver 120 is illustrated as including the control unit 125 and antenna 127 in FIG. 1, the artisan of ordinary skill will appreciate that the transceiver 120 may include additional components for performing cellular communication functions of the user equipment.

The control unit 125 may be a central processing unit (CPU), microprocessor, or other suitable data processing element for controlling operations of the transceiver 120 by executing the operating instructions, computer-readable codes, application programming, etc. stored in the memory 115 the user equipment 105 or the transceiver 120.

The transceiver 120 may also include memory, such as random access memory (RAM), solid state or flash memory, electrically erasable programmable read-only memory (EEPROM), or any other suitable data storage element for storing data and/or operating instructions, computer-readable codes, application programming, etc. of the transceiver 120.

The antenna 127 may be a multi-band mobile antenna configured to support one or more communication protocols adapted for V2X communication. The antenna 127 may be an isotropic, omnidirectional, or other antenna structurally configured to wirelessly transmit or receive data over the cellular network system 100 via the cell 150.

The control unit 125 and the antenna 127 may communicate via one or more busses 129.

Although control unit 110 and the control unit 125 are illustrated as being embodied as separate components in FIG. 1, the artisan of ordinary skill will appreciate that the control unit 110 and the control unit 125 may be integrated into a single component for controlling operations of the user equipment 105.

The cell 150 may include a control unit 160 and a transceiver 170. The cell 150 may be referred to as a network cell or a Node B, such as a an eNodeB, a gNB, and the like.

The control unit 160 includes a memory 165, processor 167, and bus 169. Although the control unit 160 is illustrated as including the memory 165, processor 167, and bus 169 in FIG. 1, the artisan of ordinary skill will appreciate that the control unit 160 may include additional components for performing functions of the cell 150.

The memory 165 may be random access memory (RAM), solid state or flash memory, electrically erasable programmable read-only memory (EEPROM), or any other suitable data storage element for storing data and/or operating instructions, computer-readable codes, application programming, etc. of the cell 150.

The processor 167 may be a central processing unit (CPU), microprocessor, or other suitable data processing element for controlling operations of the cell 150 by executing the operating instructions, computer-readable codes, application programming, etc. stored in the memory 165 the cell 150.

The memory 165 and the processor 167 may communicate via one or more busses 419.

Although the memory 165 and processor 167 are illustrated as being embodied as separate components connected via bus 169 in FIG. 1, the artisan of ordinary skill will appreciate that the memory 165 and processor 419 may be integrated into a single component, such as an application-specific integrated circuit (ASIC) or other suitable electronic component for executing functions of the cell 150.

The transceiver 170 may be communication circuitry configured to wirelessly communicate between the control unit 160 of cell 150 and a user equipment, such as the user equipment 105. The transceiver 170 may be configured to wirelessly communicate according to one or more cellular communication networks or protocols, such as 3G, 4G, LTE, 5G, 6G, GSM, GPRS, UMTS, CDMA, EDGE, and the like.

The transceiver 170 may include a control unit 175 and an antenna 177. Although the transceiver 170 may include a control unit 175 and antenna 177, the artisan of ordinary skill will appreciate that the transceiver 170 may include additional components for executing cellular transmission and reception functions of the cell 150.

The control unit 175 may be a central processing unit (CPU), microprocessor, or other suitable data processing element for controlling operations of the transceiver 170 by executing the operating instructions, computer-readable codes, application programming, etc. stored in the memory 165 the cell 150 or the transceiver 170.

The transceiver 170 may also include memory, such as random access memory (RAM), solid state or flash memory, electrically erasable programmable read-only memory (EEPROM), or any other suitable data storage element for storing data and/or operating instructions, computer-readable codes, application programming, etc. of the transceiver 170.

The antenna 177 may be a multi-band mobile antenna configured to support one or more cellular communication protocols of the cellular network system 100. The antenna 177 may be may be an isotropic, omnidirectional, or other antenna structurally configured to wirelessly transmit or receive data over the cellular network system 100.

The control unit 175 and the antenna 177 may communicate via one or more busses 179.

Although control unit 160 and the control unit 175 are illustrated as being embodied as separate components in FIG. 1, the artisan of ordinary skill will appreciate that the control unit 160 and the control unit 175 may be integrated into a single component for controlling operations of the cell 150.

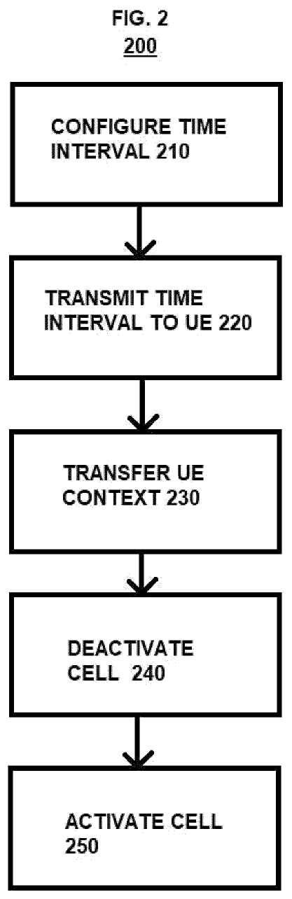

FIG. 2 is flowchart illustrating a method of controlling data transmission due to cell deactivation, according to an embodiment.

The method of controlling data transmission 200 due to cell deactivation illustrated in FIG. 2 may be performed by a cell, such as the cell 150 described with respect to FIG. 1. The method of controlling data transmission 200 due to cell deactivation illustrated in FIG. 2 may be for controlling cellular communication with a user equipment in a cellular network, such as the user equipment 105 in the cellular network system 100 described with respect to FIG. 1.

In step 210, the cell may configure a time interval for the user equipment. The cell may set the time interval based on a latency or Quality of Service (QoS) requirement of the user equipment. For example, if a quality of service required by the user equipment is low, then the cell may set the time interval to be longer, such as one second or more. Alternatively, if a quality of service required by the user equipment is high, then the cell may set the time interval to be shorter, such as 50 ms, 100 ms, or the like.

The cell may set the time interval based on a high priority logical channel (LCH). For example, the cell may set the time interval based on a highest priority logical channel of the user equipment.

In step 220, the cell may transmit the time interval to the user equipment. The cell may transmit the time interval to the user equipment by a dedicated radio resource control (RRC) message, such as an RRC reconfiguration message in UMTS, LTE, and 5G on the Air interface (Uu).

In step 230, the cell transfers context associated with the user equipment to target cells over the X2 interface, which connects neighboring cells for coordination and transfer of radio resources, to enable a seamless handover of the user equipment.

In step 240, the cell enters a deactivated mode. The cell remains in the deactivated mode for a deactivation period.

In step 250, the cell enters an activated mode after lapse of the deactivation period. In general, when entering the activated mode, neighboring cells may configure measurement resources for user equipment under their association, and a handover back to the activated cell would occur as usual if handover is triggered. However, if the user equipment handover has not occurred during the deactivation period, as discussed below, an unnecessary handover of the user equipment is prevented.

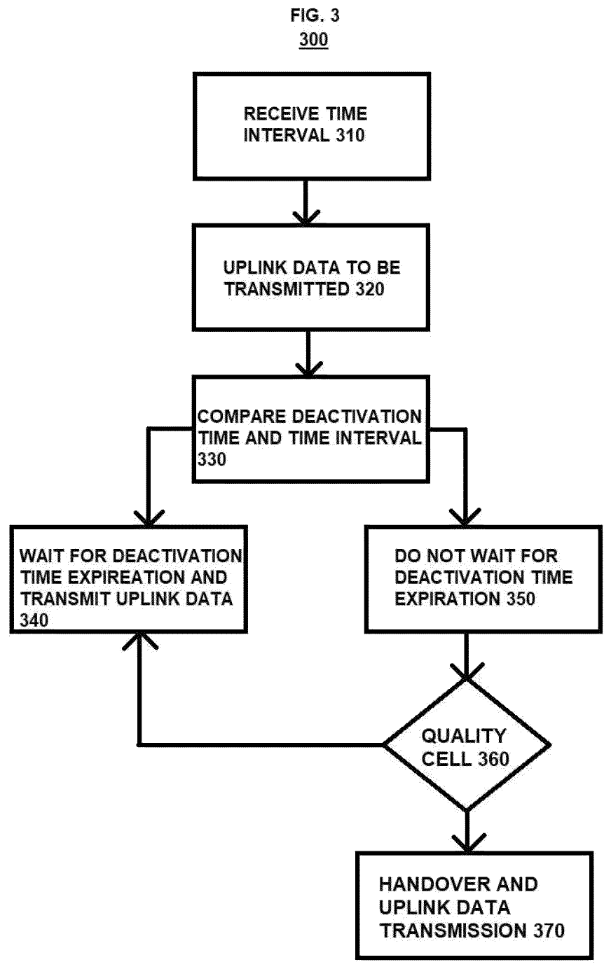

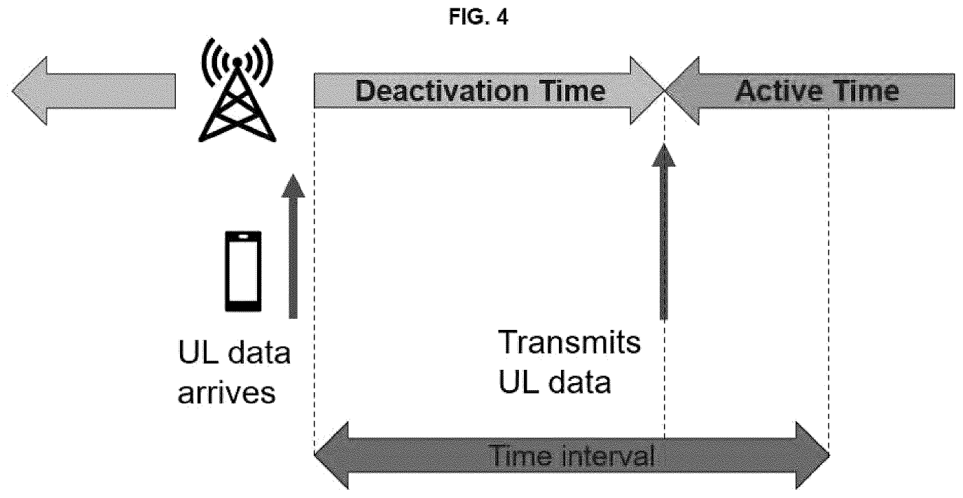

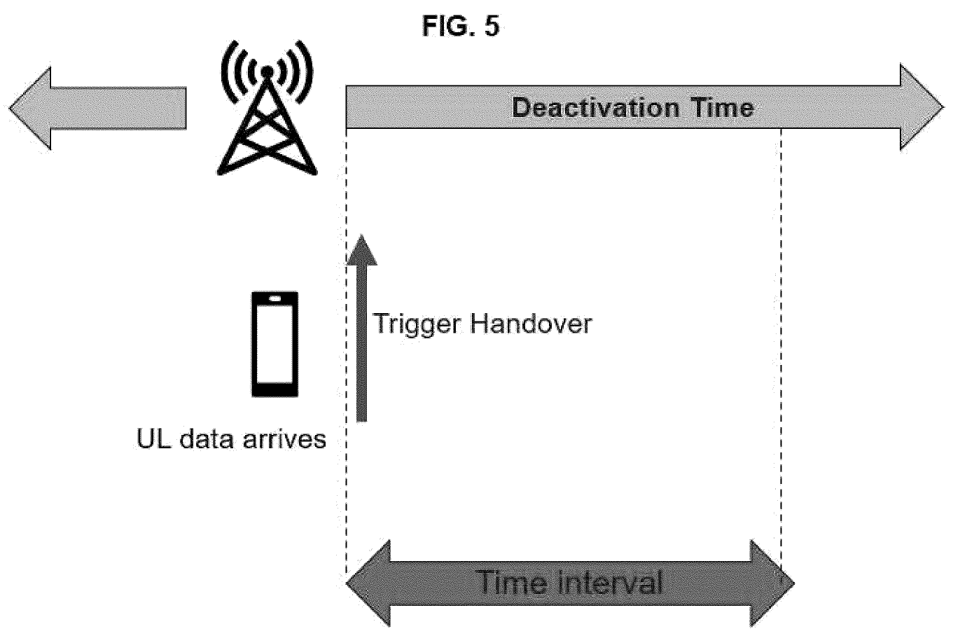

FIG. 3 is flowchart illustrating a method of controlling data transmission due to cell deactivation, according to an embodiment. FIG. 4 is a timing diagram illustrating controlling data transmission due to cell deactivation, according to an embodiment. FIG. 5 is a timing diagram illustrating controlling data transmission due to cell deactivation, according to an embodiment.

The method of controlling data transmission 300 due to cell deactivation illustrated in FIG. 3 may be performed by a user equipment, such as the user equipment 105 described with respect to FIG. 1. The method of controlling data transmission 300 due to cell deactivation illustrated in FIG. 3 may be for controlling cellular communication with a user equipment in a cellular network, such as the user equipment 105 in the cellular network system 100 described with respect to FIG. 1.

In step 310, the user equipment may receive a time interval from the serving cell. The time interval may be set based on a latency or Quality of Service (QoS) requirement of the user equipment transmitted to the cell. For example, if a quality of service required by the user equipment is low, then the time interval may be increased, such as one second or more. Alternatively, if a quality of service required by the user equipment is high, then the time interval may be reduced, such as 50 ms, 100 ms, or the like.

The Quality of Service may be determined by the user equipment according to one or more applications executed by the user equipment, which may utilized one or more logical channels for the reception and transmission of data over the cellular network.

The user equipment may also receive a deactivation time and/or the deactivation period from the cell. Accordingly, the user equipment may determine a time and a period at which the cell may be deactivated for reception of uplink data from the user equipment based on the deactivation time and/or the deactivation period.

The UE may receive the time interval and the deactivation period and/or deactivation time from the cell via a dedicated radio resource control (RRC) message, such as an RRC reconfiguration message in UMTS, LTE, and 5G on the Air interface (Uu).

In step 320, the user equipment determines that uplink data is to be transmitted to the target cell.

In step 330, the user equipment compares a remaining deactivation time of the cell to a time interval of the UE for transmitting uplink data to the target cell.

FIG. 4 illustrates a timing diagram illustrating controlling data transmission due to cell deactivation, according to an embodiment. With reference to FIGS. 3 and 4, in step 340, if the user equipment determines that a remaining deactivation time of the cell is less than a time interval of the user equipment for transmitting uplink data to a target cell, the user equipment waits until expiration of the deactivation time of the serving cell. Upon expiration of the deactivation time, the serving cell is transitioned into the active state, and the user equipment performs uplink data transmission in the serving cell.

FIG. 5 illustrates a timing diagram illustrating controlling data transmission due to cell deactivation, according to an embodiment. With reference to FIGS. 3 and 5, in step 350, if the user equipment determines that a remaining deactivation time of the cell is greater than a time interval of the user equipment for transmitting uplink data to a target cell, the user equipment does not wait until expiration of the deactivation time of the serving cell. The serving cell being deactivated acts as an override condition to a usual conditional handover procedure. Since the serving cell has already transferred the context of the user equipment to a target cell(s) of the user equipment via X2 signaling, the user equipment can directly transmit uplink (UL) data to a target cell without performing the random access channel (RACH) procedure.

In step 360, before performing a handover, the user equipment checks a quality of inter cell and intra-cell parameters. If a cell of sufficient quality is identified by the user equipment, then the user equipment performs a handover process with the new cell, in step 370, and performs uplink data transmission with the new cell. Otherwise, if a cell of sufficient quality is not identified by the user equipment, then the user equipment waits for the expiration of the deactivation period in step 340. Uplink data transmission is then performed via the serving cell.

Accordingly, data transmission latency and signaling overhead may be reduced.

Furthermore, a decision on handover may be selected by the user equipment based on the QoS (latency requirement) of the user equipment. For example, if quality of service is low, the user equipment can determine to wait until expiration of the deactivation period of the current cell. If quality of service is high, then the user equipment may alternatively attempt to transmit using target cell.

Aspects of the embodiments described herein may be implemented as computer programs written as computer-executable codes or instructions, whether compiled or uncompiled. The computer programs may be recorded on one or more computer-readable media, such as disk, CD-ROM, or other memory, such as RAM, ROM, flash or solid state memory, etc. Upon execution of the computer programs by a processor, microprocessor, or other processing device, the processor may control a device, such as a user equipment or cell in a cellular network to provide for uplink data transmission in consideration of cellular network power savings through deactivation of cells in the cellular network.

### INDUSTRIAL APPLICABILITY

Embodiments of the present application are relevant for cellular communication networks, and more particularly to provide for network energy savings in the instance in which a cell may be deactivated while maintaining appropriate data transmission, which is important for network reliability.

### REFERENCE SIGNS LIST

100 Cellular Network System
105 User Equipment
110 Control Unit
115 Memory
117 Processor
119 Bus
120 Transceiver
125 Control Unit
127 Antenna
129 Bus
150 Cell
160 Control Unit
165 Memory
167 Processor
169 Bus
170 Transceiver
175 Control Unit
177 Antenna
179 Bus

1. A cellular network system comprising:
a user equipment; and
a network cell configured to determine a time interval for uplink data transmission of the user equipment according to a quality of service of the user equipment and transmit the time interval to the user equipment,
wherein the user equipment is configured to compare a remaining deactivation time of the network cell to the time interval and perform uplink data transmission in the network cell or a target cell based on a result of comparing the deactivation time to the time interval.

2. The cellular network system according to claim 1, wherein the user equipment receives the time interval from the network cell via a radio resource control (RRC) message.

3. The cellular network system according to claim 1, wherein the user equipment is configured to determine the remaining deactivation time is less than the time interval and perform uplink data transmission in the network cell upon expiration of the remaining deactivation time.

4. The cellular network system according to claim 1, wherein the user equipment is configured to determine the remaining deactivation time is greater than the time interval, perform handover from the network cell to a target network cell, and perform uplink data transmission in the target network cell.

5. The cellular network system according to claim 4, wherein the user equipment is configured to perform the handover from the network cell to the target network cell prior to expiration of the remaining deactivation time.

6. The cellular network system according to claim 5, wherein the network cell is configured to transfer context of the user equipment to the target cell and deactivate the network cell for a period of the deactivation time.

7. A user equipment comprising:
a transceiver; and
a control unit configured to receive from a network cell servicing the user equipment a time interval of the user equipment based on a quality of service requirement of the user equipment, compare a remaining deactivation time of the network cell to the time interval, and control the transceiver to perform uplink data transmission in the network cell or a target cell based on a result of comparing the deactivation time to the time interval.

8. The user equipment according to claim 7, wherein the control unit is configured to control the transceiver to receive the time interval from the network cell via a radio resource control (RRC) message.

9. The user equipment according to claim 7, wherein the control unit is configured to determine the remaining deactivation time is less than the time interval and control the transceiver to perform uplink data transmission in the network cell upon expiration of the remaining deactivation time.

10. The user equipment according to claim 7, wherein the control unit is configured to determine the remaining deactivation time is greater than the time interval, perform handover from the network cell to a target network cell, and control the transceiver to perform uplink data transmission in the target network cell.

11. The user equipment according to claim 10, wherein the control unit is configured to perform the handover from the network cell to the target network cell prior to expiration of the remaining deactivation time.

12. A method of a user equipment controlling data transmission in a cellular network system according to cell deactivation, the method comprising:
receiving from a network cell servicing the user equipment a time interval of the user equipment based on a quality of service requirement of the user equipment;
comparing a remaining deactivation time of the network cell to the time; and
performing uplink data transmission in the network cell or a target cell based on a result of comparing the deactivation time to the time interval.

13. The method according to claim 12, wherein receiving the time interval comprises receiving the time from the network cell via a radio resource control (RRC) message.

14. The method according to claim 12, further comprising:
determining the remaining deactivation time is less than the time interval; and
performing the uplink data transmission in the network cell upon expiration of the remaining deactivation time.

15. The method according to claim 12, further comprising:
determining the remaining deactivation time is greater than the time interval;
performing the handover from the network cell to a target network cell; and
performing uplink data transmission in the target network cell.

16. The method according to claim 15, wherein performing the handover comprises performing the handover from the network cell to the target network cell prior to expiration of the remaining deactivation time.
